(19) United States
(12) Patent Application Publication
(10) Pub. No.: US 2018/0357628 A1
(43) Pub. Date: Dec. 13, 2018

(54) ELECTRONIC SYSTEM AND METHOD FOR SPLITTING A TRANSACTION COST BETWEEN MULTIPLE PARTIES

(71) Applicant: Mastercard International Incorporated, Purchase, NY (US)

(72) Inventors: Fabiano Vergari, West Bridgford (GB); Ashutosh Sharan, Gurgaon (IN)

(73) Assignee: Mastercard International Incorporated, Purchase, NY (US)

(21) Appl. No.: 16/006,611

(22) Filed: Jun. 12, 2018

(30) Foreign Application Priority Data
Jun. 12, 2017 (IN) 201741020430

(51) Int. Cl. G06Q 20/22; G06Q 20/34; G06Q 20/42; G06Q 20/32

(52) U.S. Cl. CPC G06Q 20/29; G06Q 20/3278; G06Q 20/425; G06Q 20/34

(57) ABSTRACT

An electronic system for splitting a transaction cost between multiple parties. The system comprises a processor configured to: receive transaction data from a payment card server, the transaction data relating to transactions performed using a payment card associated with a first user; on instruction by the first user, associate one or more other users with a group transaction identified from the transaction data along with an indication of a respective portion of the group transaction to be paid by each other user; transmit a payment authorization request to each other user for payment of the other user's respective portion of the group transaction; and upon authorization, receive confirmation of a transfer of funds equal to the other user's respective portion from a payment vehicle associated with the other user to a payment account associated with the first user.

### CROSS REFERENCE TO RELATED APPLICATIONS

This application claims priority to Indian Application Serial No. 201741020430, filed Jun. 12, 2017, which is incorporated herein by reference in its entirety.

### FIELD OF THE INVENTION

The present invention relates to an electronic system and method for splitting a transaction cost between multiple parties. In particular, the invention may be applied to the splitting of a restaurant bill between people dining together.

### BACKGROUND OF THE INVENTION

Traditionally, when multiple parties dine together, it is necessary to calculate the proportion of the bill that each diner owes so they can contribute the funds required for their part of the meal to the merchant. Once the individual proportions are calculated each person contributes with cash or pays their own portion using a credit card, debit card or other acceptable payment mechanism. This process is often time-consuming and can require parties to exchange cash and give change or charge portions on a number of different credit/debit cards which is inconvenient for the merchant.

It is now possible to split a taxi fare amongst friends using a mobile application in the name of Uber™. However, this application requires the fare to be split before any payment is made. In other words, a person booking a fare informs the application of the friends that will share the cost of the fare before any transaction takes place and, once they each confirm the split, separate payments are made from each individual directly to the merchant. However, this method is only possible when the individuals are able to authorise the payment prior to the transaction being made. It also requires the merchant to process multiple transactions—one for each person contributing to the cost. Accordingly, there is a burden on each individual to authorise the transaction before the merchant can be assured that the total payment will be received and this may only be practical if all of the individuals concerned are present at the time of the transaction split.

Consequently, there is a need for an improved system and method for splitting a transaction cost between multiple parties.

### SUMMARY OF THE INVENTION

In accordance with a first aspect of the present invention there is provided an electronic system for splitting a transaction cost between multiple parties comprising a processor configured to:
a) receive transaction data from a payment card server, the transaction data relating to transactions performed using a payment card associated with a first user;
b) on instruction by the first user, associate one or more other users with a group transaction identified from the transaction data along with an indication of a respective portion of the group transaction to be paid by each other user;
c) transmit a payment authorization request to each other user for payment of the other user's respective portion of the group transaction; and
d) upon authorization, receive confirmation of a transfer of funds equal to the other user's respective portion from a payment vehicle associated with the other user to a payment account associated with the first user.

Embodiments of the present aspect of the invention therefore provide an electronic system which can be used to quickly and effectively split a transaction cost between multiple parties after a first user has paid for the entire bill in a single transaction with the merchant. This makes payment to the merchant much simpler and faster and also enables the first user to be paid back by the other parties directly into the first user's account. There is no need to exchange cash or make several separate card transactions with the merchant. Furthermore, there is no need to make any changes to the merchant's point of sale terminal. As far as the merchant is concerned the bill is settled in its entirety by the first user and the other users simply pay the first user their respective portions of the total cost. Notably, the present invention relates to the splitting of a transaction cost with multiple parties after full payment of the transaction amount has been paid to the merchant. In other words, the invention relates to a post-transaction splitting of an amount already paid by one customer on behalf of a group of people. This is preferable to a pre-transaction cost splitting because it does not require all contributors to be present or to agree to the transaction prior to or at the time of the payment to the merchant. It also simplifies the payment process from the merchant perspective because only a single transaction is required to the merchant settle the cost in full.

The processor may be incorporated in a personal electronic device of the first user (e.g. smartphone, personal digital assistant, tablet, laptop, personal computer or keyfob).

The processor may be configured to run an application (“App”) stored in a memory in the personal electronic device to carry out the steps a) to d).

Notably, the transaction may be split almost immediately after the transaction between the first user and the merchant has been completed, when the transaction data is received from the payment card server. Alternatively, the transaction may be split at a future date or time. For example, a restaurant bill may be split immediately as all parties contributing to the bill will be present and ready to pay the bill after dining. On the other hand, a group present (e.g. for a colleague, relative or friend) may be purchased by the first user without the other potential contributors being there. In this case, the first user may first inform the other potential contributors about the present he/she has purchased and get their agreement to contribute. The first user may then initiate the split of the transaction cost with all those who have agreed to contribute at a later date or time.

It will be understood that the splitting of the group transaction may be performed evenly (i.e. by dividing the total cost between the number of users contributing funds) or each user may contribute a specified amount (i.e. to only pay for the food or drink they have consumed).

The processor may be further configured to perform a registration process whereby the first user registers at least one payment card for subsequently receiving the transaction data from the payment card server.

The process of receiving the transaction data from the payment card server may comprise the processor transmitting a request to the payment card server for access to the transaction data relating to transactions performed using the registered payment card. The request may comprise a password or PIN pre-registered with the payment card server and entered by the first user into the application to authorize the transmittal of transaction data from the payment card server. If the password/Pin is correct, the payment card server may transmit the transaction data to the processor via the personal electronic device. The transmittal may be via 3G, 4G, WiFi or another communication channel. Whenever a subsequent transaction takes place using the payment card, the payment card server may immediately transmit the transaction data associated with the subsequent transaction to the processor via the personal electronic device, as soon as the transaction is authorized. Accordingly, the first user will be able to view transaction data for all transactions made using the payment card soon after the transaction has been performed. The transaction data may be stored in a memory of the personal electronic device. To limit the amount of memory required to store the transaction data, transactions that occurred more than a predefined duration ago may be deleted. For example, transactions that occurred more than 1 year, 6 months, 3 months, 2 months or 1 month ago may be deleted from the memory of the personal electronic device. The first user may be able to select the duration for which transaction data is retained in the memory.

The transaction data may comprise the date, time, location, merchant name, merchant ID and total cost of the transaction.

The first user may associate the other users with the group transaction by selecting the other users from an address or phone book stored in a memory on the first user's personal electronic device. The address or phone book may comprise the other user's name, user ID, mobile phone number and/or email address.

In some embodiments, the first user may be able to create a friend group via the application comprising details of the other users that the first user frequently does group activities with and may wish to split transactions with. In which case, the friend group can be stored in the memory and selected by the first user when they wish to split a transaction with each of the members of that friend group. There may be an option to add or remove friends from the friend group for each group transaction.

In accordance with step b) the first user may select the other users for the transaction split and enter the amount each other user is to pay. Alternatively, the first user may select to divide the transaction cost equally amongst all users contributing (including themselves) and the application may calculate the cost each individual user is to pay. Where a straight split would result in a fraction being owed, the cost to each other user may be rounded down to the nearest whole monetary denomination with the remaining balance to be paid by the first (or a selected individual) user.

The payment authorisation request may be transmitted to each other user via a mobile internet connection (e.g. 3G or 4G) or a Near Field Communication (NFC) “tap” between the first user's personal electronic device and that of the other user.

If the other user already has the application on their personal electronic device, the request may cause the application to open and prompt the other user to authorise a payment for a specified amount to the first user in relation to a group transaction. Transaction data may be provided for the other user's information which may comprise the total cost of the group transaction, the name of the merchant with whom the group transaction was made, the name of the first user initiating the split of the transaction and the names of the other users associated with the group transaction (if any).

If the other user does not already have the application on their personal electronic device, the request may cause the personal electronic device to prompt the other user to download the application on their personal electronic device and register their details. The other user registration process maybe similar to the first user registration process and may comprise the other user registering at least one payment vehicle associated with the other user for use in paying the first user for a group transaction.

It may be possible to register with the application only as a first user (i.e. initial payer for the group transaction) or other user (i.e. to pay the first user back) or the registration process may be the same for all users so that any user may take the role of the first user or one of the other users as described above. The registration process may therefore comprise registering at least one payment card for subsequently receiving the transaction data from the payment card server and at least one payment vehicle for use in paying the first user for a group transaction. The payment card and payment vehicle may be the same or different as specified by the user.

The request may comprise the respective portion of the group transaction owed by the other user, the name of the first user requesting payment, the merchant name associated with the group transaction, the names of the other user's (if any) from whom the first user has also requested payment and the total cost of the group transaction.

The other user may authorize the payment by entering a password or PIN into the application for verification purposes. The application may then cause the personal electronic device to send a payment request (including the password/PIN, details of the respective portion of the group transaction to be paid by the other user and details of the payment account associated with the first user) to an issuer bank associated with the payment vehicle registered by the other user. The issuer bank will verify the password/PIN against a record for the payment vehicle in its memory and if the password/PIN matches the record, the payment will be made from the issuer bank via a payment network to the payment account associated with the first user. If the password/PIN does not match the record, a notification will be relayed back to the other user's personal electronic device and a re-entry of the password/PIN may be requested.

If the other user does not wish to pay the respective portion notified in the payment authorisation request, he/she may refuse to proceed with the payment and the application may cause a message to be sent to the first user's personal electronic device to notify the first user of the rejection.

Each other user's payment to the first user will be listed in their respective transaction data histories and may comprise the amount they paid, first user's name and merchant name associated with the group transaction. Furthermore, the first user's transaction data history may include details of the original amount paid by the first user to the merchant plus the amounts received from each other user associated with the group transaction and which may also include reference to the relevant group transaction and/or merchant.

In accordance with a second aspect of the present invention there is provided a computerized method for splitting a transaction cost between multiple parties comprising:
a) receiving, by a processor, transaction data from a payment card server, the transaction data relating to transactions performed using a payment card associated with a first user;
b) on instruction by the first user, associating one or more other users with a group transaction identified from the transaction data along with an indication of a respective portion of the group transaction to be paid by each other user;
c) transmitting a payment authorization request to each other user for payment of the other user's respective portion of the group transaction; and
d) upon authorization, receiving confirmation of a transfer of funds equal to the other user's respective portion from a payment vehicle associated with the other user to a payment account associated with the first user.

The method may be implemented on a user device such as a personal electronic device, mobile phone, personal computer, tablet, laptop, key-fob or personal digital assistant (PDA). The user device may be in communication with a payment card server which in turn may be in communication with an issuer bank. Alternatively, the user device may be in direct communication with the issuer bank.

As used throughout this specification, the terms payment card and payment vehicle may comprise any suitable cashless payment mechanism, such as a credit card, a debit card, a prepaid card, a charge card, a membership card, a promotional card, a frequent flyer card, an identification card, a gift card, and/or any other physical or electronic device that may hold payment account information, such as digital wallets.

Embodiments of the invention may be expressed as a network of communicating devices (i.e. a “computerized network”). It may further be expressed in terms of a software application downloadable into a computer device to facilitate the method. The software application may be a computer program product, which may be stored on a non-transitory computer-readable medium on a tangible data-storage device (such as a storage device of a server, or one within a user device).

### BRIEF DESCRIPTION OF THE DRAWINGS

Embodiments of the invention will now be described by way of example only with reference to the following drawings, in which:

FIG. 1 illustrates a method for splitting a transaction cost between multiple parties in accordance with a first embodiment of the invention;

FIG. 2 illustrates a computerised network of electronic devices for performing the method of FIG. 1;

FIG. 3 shows a flow chart for a registration procedure for splitting a transaction cost between multiple parties in accordance with an embodiment of the invention;

FIG. 4 shows a flow chart for making a group transaction payment in accordance with an embodiment of the invention;

FIG. 5 shows a more detailed flow chart for splitting a transaction cost between multiple parties in accordance with an embodiment of the invention;

FIG. 6 shows a block diagram of a server of FIG. 2; and

FIG. 7 shows a block diagram of a mobile of FIG. 2.

### DETAILED DESCRIPTION OF CERTAIN EMBODIMENTS

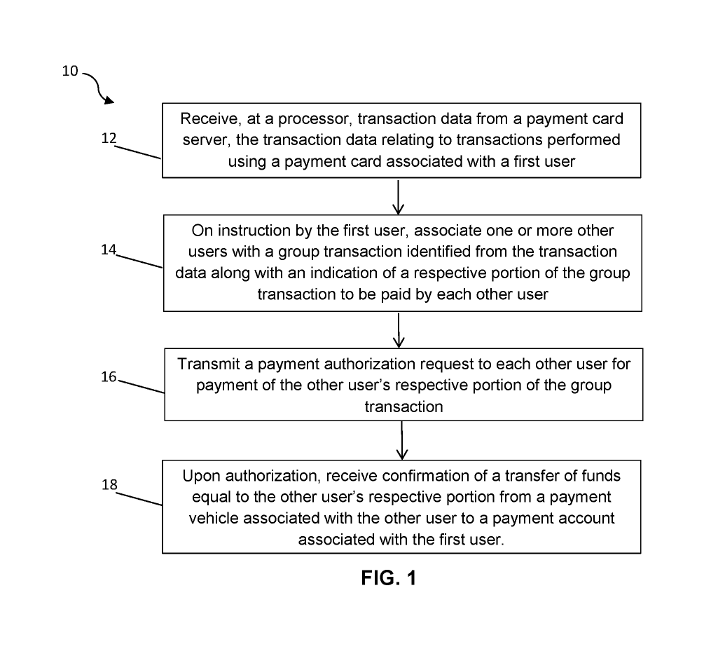

FIG. 1 shows a computerized method 10 for splitting a transaction cost between multiple parties in accordance with a first embodiment of the invention. The method 10 comprises the following steps:

Step 12: receiving, by a processor, transaction data from a payment card server, the transaction data relating to transactions performed using a payment card associated with a first user;

Step 14: on instruction by the first user, associating one or more other users with a group transaction identified from the transaction data along with an indication of a respective portion of the group transaction to be paid by each other user;

Step 16: transmitting a payment authorization request to each other user for payment of the other user's respective portion of the group transaction; and

Step 18: upon authorization, receiving confirmation of a transfer of funds equal to the other user's respective portion from a payment vehicle associated with the other user to a payment account associated with the first user.

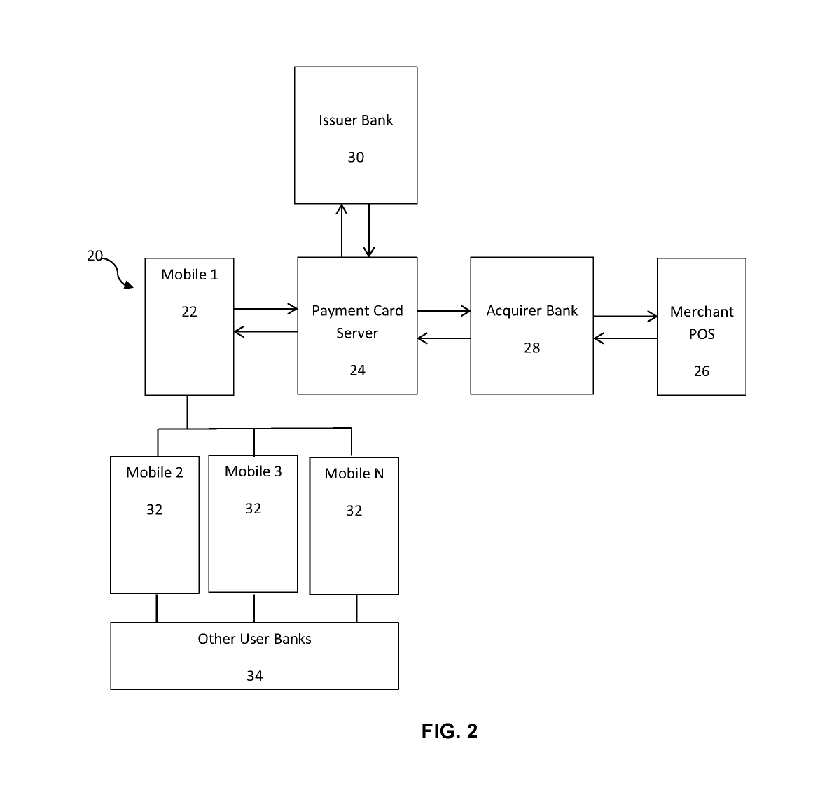

FIG. 2 illustrates a computerized network or system 20 of electronic devices for performing the method of FIG. 1. Thus, the network 20 comprises a personal electronic device of a first user in the form of a mobile phone 22 (denoted mobile 1) which is connected via a communication network (i.e. a mobile 3G or 4G communication network) to a payment card server 24 for receiving the transaction data relating to transactions performed using a payment card associated with the first user.

When a group of N friends including the first user wish to jointly pay for a transaction at a merchant point-of-sale (POS) terminal 26, the first user agrees to pay the group transaction in full using his/her payment card and the remaining friends (i.e. other users) agree to pay the first user back for their respective portions of the total transaction cost. Thus, only a single transaction is performed with the merchant using the first user's payment card. The merchant POS 26 then sends a payment request via a payment network, in the standard way (i.e. an authorization request is sent to an acquirer bank 28, which in turn is sent to an issuer bank 30 via the payment card server 24 and an authorization response is returned from the issuer bank 30 via the payment card server 24 to the acquirer bank 28 and merchant POS 26).

The payment card server 24 will then update the first user's mobile 1 with the transaction details including the total transaction cost and merchant name. Accordingly, a processor of the mobile 1 will receive transaction data from the payment card server 24 in accordance with step 12 of FIG. 1.

In accordance with step 14, the first user will be able to identify, from the transaction data, a group transaction (i.e. one which he/she has paid on behalf of a group of people) and then associate one or more other users with the group transaction along with an indication of a respective portion of the group transaction to be paid by each other user. The portions may be individually specified by the first user or the total cost of the group transaction may be divided equally between all of the users contributing to the group transaction. In the case of a fraction being owed, one user may pay slightly more than the other users.

The other users may be identified from a phone book or address list held in a memory of the first user's mobile 1 or they may be selected from a pre-defined friend group established on an application configured to implement the method of FIG. 1 on the mobile 1.

The other user's may be identified by their mobile phone numbers (or email addresses) such that a payment authorisation request can be sent to each other user, for payment of the other user's respective portion of the group transaction, using the mobile number or email address of that user. The request may be transmitted over a mobile communication network, NFC or WiFi connection. Accordingly, each other user numbered 2 to N will receive the request on their respective personal electronic devices 32 denoted mobile 2, 3 . . . N.

As will be explained in more detail below, each other user 2 to N will be able to accept or reject the payment request using their mobiles 2 to N. If the payment request is accepted by one of the other users, he/she will instruct payment of his/her respective portion of the group transaction to the first user's specified account, through his/her respective bank 34. This may be done using a payment vehicle pre-registered with an application running on his/her mobile 2 to N.

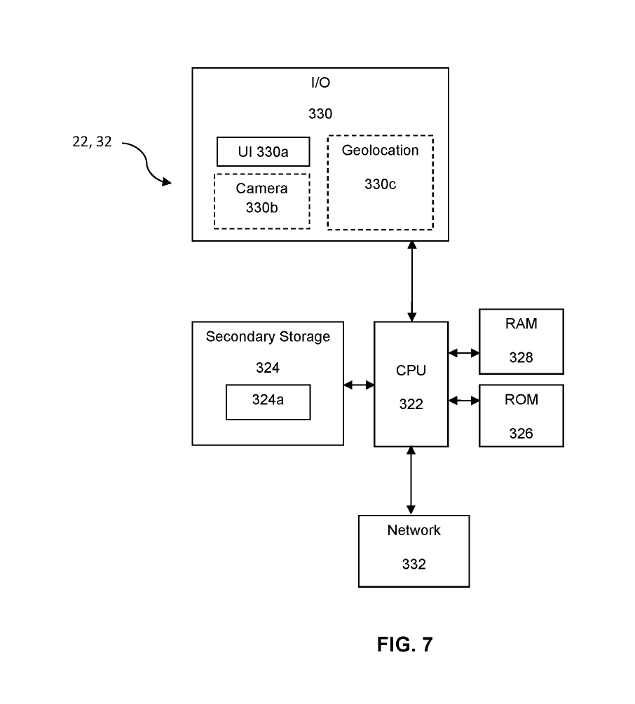

The mobiles 1 to N may be constituted as smartphones, however they may each be constituted by any personal electronic device, such as a tablet computer, laptop, personal computer or keyfob. In general terms, the mobiles 1 to N can be considered to be communication devices (which are described below in more detail with reference to FIG. 7). They all may include screens and input devices. The screens may be touch sensitive, in which case separate input devices may not be required and the screens alone may provide a user interface for the communication device. All of the mobiles 1 to N are able to communicate via a communication network using respective communication interfaces (not shown). The communication devices may communicate with the communication network via a wireless connection (e.g. GPRS, 3G, 4G, WIFI or Bluetooth) or a wired connection.

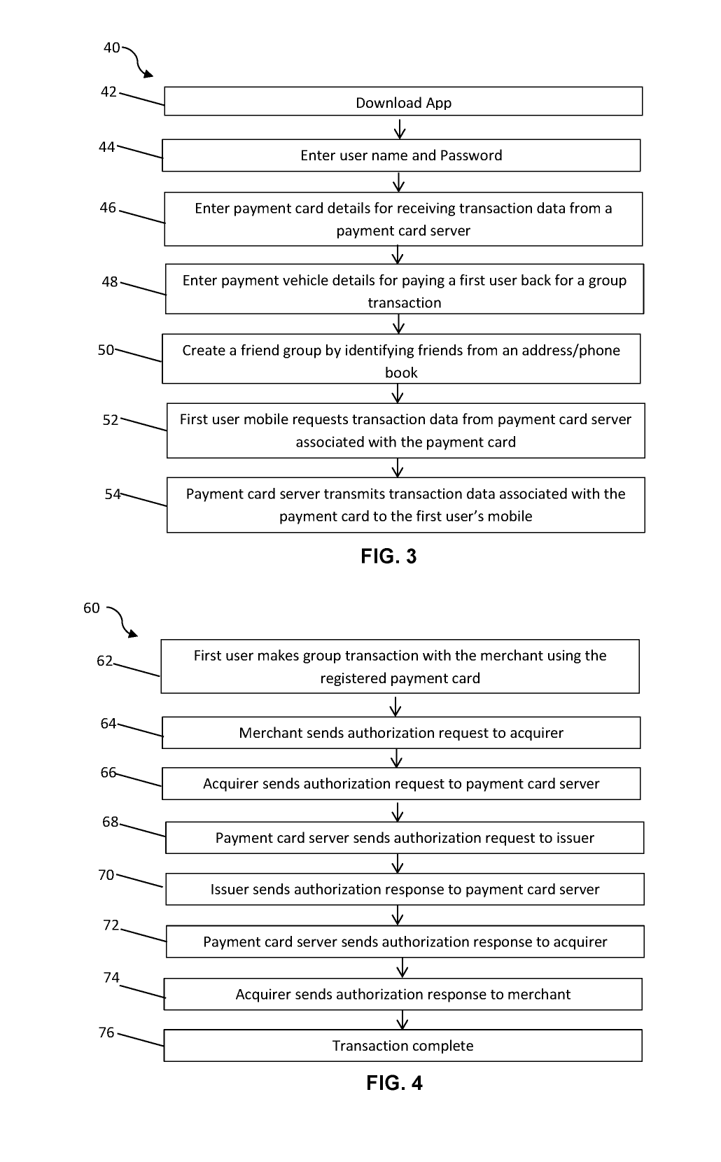

With reference to FIG. 3, there is illustrated a registration procedure 40 for splitting a transaction cost between multiple parties in accordance with an embodiment of the invention. In this embodiment, the procedure 40 is carried out by a user (who may be the first user or one of the other users) via a user application (App) operating on the user's mobile 1 to N.

In a first step 42, the user downloads the App and then establishes a username and password in step 44. In step 46 the user enters the payment card details (e.g. card number, expiry date, CCV and name on the card) for receiving transaction data from the payment card server 24. This is the card that the user may wish to use for group transactions.

In step 48, the user may also enter details of a payment vehicle for paying a first user back for a group transaction. This payment vehicle may be the payment card identified in step 46 or it may be a different payment vehicle.

In step 50, the user may create a friend group to be stored in a memory associated with the App by identifying friends from an address or phone book. The friend group may comprise friends, relatives or colleagues that participate in joint activities (e.g. dining together) for future use in a connection with a group transaction in accordance with embodiments of the present invention.

In the step 52, the first user mobile 1 requests transaction data from the payment card server 24 associated with the registered payment card. The payment card server 24 then responds in step 54 by transmitting the transaction data associated with the registered payment card to the first user's mobile 1. The transaction data may comprise historical data for all transactions that have occurred in a given time-frame (e.g. the last month, 3 months, 6 months etc.). The transaction data may include at least the date, time, name of merchant and transaction cost.

FIG. 4 illustrates a method 60 of processing a group transaction by a merchant. In this case, the group transaction is initiated by the first user paying the merchant for the total cost of the group transaction using the registered payment card in step 62. The approval and payment process is then carried out in accordance with standard practice. Thus, the merchant POS 26 sends an authorization request to the acquirer bank 28 in step 64, the acquirer bank 28 sends the authorization request to the payment card server 24 in step 66 and the payment card server 24 sends the authorization request to the issuer bank 30 in step 68. In step 70, the issuer bank 30 sends an authorization response to the payment card server 24, in step 72 the payment card server 24 sends the authorization response to the acquirer bank 28 and in step 74 the acquirer bank 28 sends the authorization response to the merchant POS 26. In step 76, the transaction is complete and, if the authorization response is positive the funds are deducted from the payment card/issuer bank 30 by the payment card server 24 and transferred to the acquirer bank 28 for payment into the merchant's account. Accordingly, the merchant receives a single payment from the first user to settle the entire group transaction.

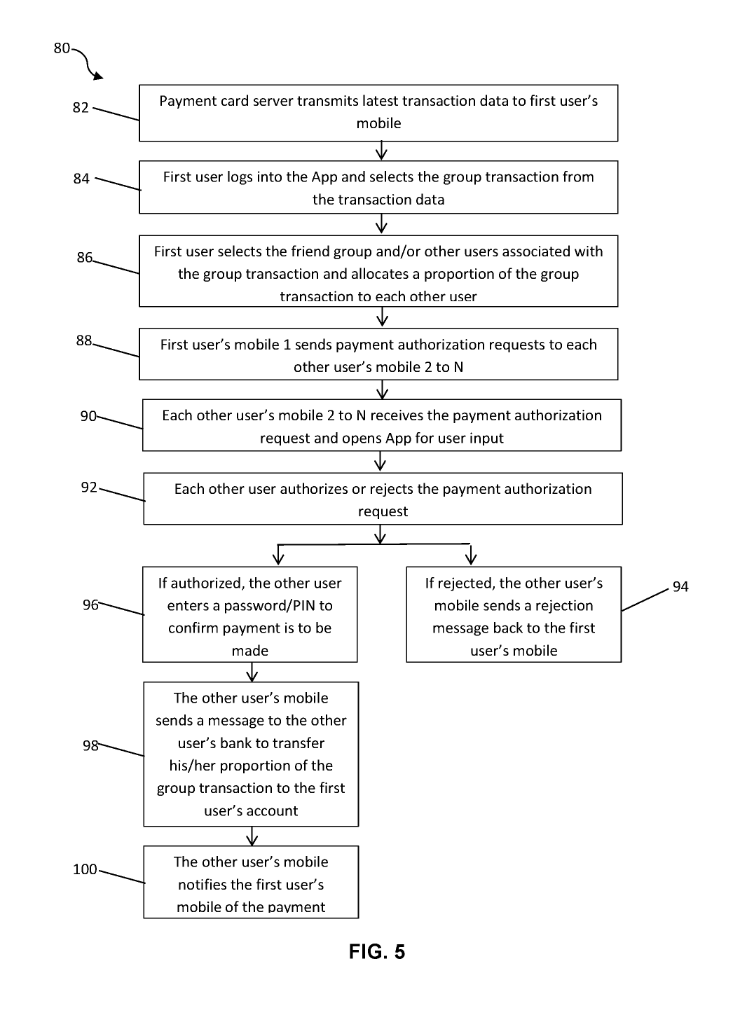

FIG. 5 shows more detailed steps in a method 80 for splitting a transaction cost between multiple parties in accordance with an embodiment of the invention. In this case, the registration procedure 40 has already been performed by at least the first user involved in the group transaction and the group transaction has been processed by the merchant in accordance with FIG. 4.

In step 82, the payment card server 24 transmits the latest transaction data to the first user's mobile 1. In step 84, the first user logs into the App (using the registered username and password) and selects the group transaction from the transaction data. The group transaction may be the latest transaction or an earlier transaction.

The first user then selects, in step 86, the friend group and/or other users to be associated with the group transaction and allocates a proportion of the group transaction to each user. As mentioned previously, the other users may be identified by their mobile phone numbers or email addresses. The first user's mobile then, in step 88, transmits a payment authorization request to each other user's mobiles 2 to N (e.g. by SMS or email).

In step 90, each other user's mobile 2 to N receives the payment authorization request and open the App for user input. If the user has already registered with the App in accordance with FIG. 3, the user will be prompted to enter their username and password. If the user has not registered with the App, the user will be prompted to follow the registration process of FIG. 3.

In step 92, the other users will be required to authorize or reject the payment authorization request, which will include details of the first user (e.g. name, mobile phone number and account details for payment), the merchant name and the proportion of the group transaction to be paid by the other user.

If, in step 94, the other user rejects the payment authorization request (e.g. if they were included in a friend group but did not attend the event that the group transaction relates to), the other user's mobile will send a rejection message back to the first user's mobile (e.g. by SMS or email).

If, in step 96, the other user authorizes the payment authorization request they may be required to enter a password or PIN to confirm that the payment is to be made using the payment vehicle registered with the App. The other user's mobile then, in step 98, sends a message to the other user's bank 34 (i.e. associated with the registered payment vehicle) to transfer his/her proportion of the group transaction to the first user's account.

In step 100, the other user's mobile notifies the first user's mobile of the payment by the other user. Thus, the first user will receive notifications of all payments and rejections made in response to the payment authorization requests. Furthermore, the App may notify the first user if no response is received from one or more of the other users in response to the payment authorization request so that he/she can chase the other users for payment, if necessary.

It will therefore be apparent that embodiments of the invention provide a method and system for splitting a transaction cost between multiple parties that is more convenient for both customers and merchants. From the merchant's perspective no changes are required to the POS terminal and only a single transaction is required to be performed on behalf of the whole group. From the customer's perspective, no cash needs to change hands and the funds owing by each individual can quickly be paid electronically.

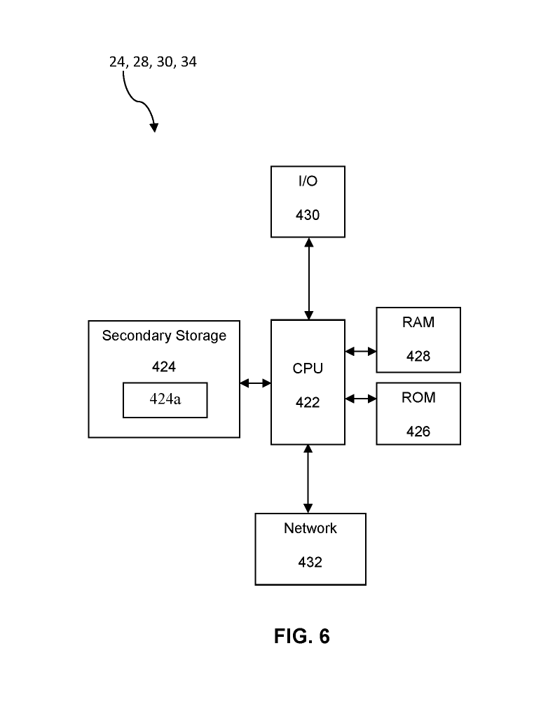

FIG. 6 is a block diagram showing a technical architecture of the payment card server 24. The issuer bank 30 server, acquirer bank 28 server and other user's bank 34 servers may also have this technical architecture.

The technical architecture includes a processor 422 (which may be referred to as a central processor unit or CPU) that is in communication with memory devices including secondary storage 424 (such as disk drives), read only memory (ROM) 426, random access memory (RAM) 428. The processor 422 may be implemented as one or more CPU chips. The technical architecture may further comprise input/output (I/O) devices 430, and network connectivity devices 432.

The secondary storage 424 is typically comprised of one or more disk drives or tape drives and is used for non-volatile storage of data and as an over-flow data storage device if RAM 428 is not large enough to hold all working data. Secondary storage 424 may be used to store programs which are loaded into RAM 428 when such programs are selected for execution.

In this embodiment, the secondary storage 424 has a processing component 424a comprising non-transitory instructions operative by the processor 422 to perform various operations of the method of the present disclosure. The ROM 426 is used to store instructions and perhaps data which are read during program execution. The secondary storage 424, the RAM 428, and/or the ROM 426 may be referred to in some contexts as computer readable storage media and/or non-transitory computer readable media.

I/O devices 430 may include printers, video monitors, liquid crystal displays (LCDs), plasma displays, touch screen displays, keyboards, keypads, switches, dials, mice, track balls, voice recognizers, card readers, paper tape readers, or other well-known input devices.

The network connectivity devices 432 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 432 may enable the processor 422 to communicate with the Internet or one or more intranets. With such a network connection, it is contemplated that the processor 422 might receive information from the network, or might output information to the network in the course of performing the above-described method operations. Such information, which is often represented as a sequence of instructions to be executed using processor 422, may be received from and outputted to the network, for example, in the form of a computer data signal embodied in a carrier wave.

The processor 422 executes instructions, codes, computer programs, scripts which it accesses from hard disk, floppy disk, optical disk (these various disk based systems may all be considered secondary storage 424), flash drive, ROM 426, RAM 428, or the network connectivity devices 432. While only one processor 422 is shown, multiple processors may be present. Thus, while instructions may be discussed as executed by a processor, the instructions may be executed simultaneously, serially, or otherwise executed by one or multiple processors.

Although the technical architecture is described with reference to a computer, it should be appreciated that the technical architecture may be formed by two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the technical architecture 420 to provide the functionality of a number of servers that is not directly bound to the number of computers in the technical architecture 420. In an embodiment, the functionality disclosed above may be provided by executing the application and/or applications in a cloud computing environment. Cloud computing may comprise providing computing services via a network connection using dynamically scalable computing resources. A cloud computing environment may be established by an enterprise and/or may be hired on an as-needed basis from a third party provider.

It is understood that by programming and/or loading executable instructions onto the technical architecture, at least one of the CPU 422, the RAM 428, and the ROM 426 are changed, transforming the technical architecture in part into a specific purpose machine or apparatus having the novel functionality taught by the present disclosure. It is fundamental to the electrical engineering and software engineering arts that functionality that can be implemented by loading executable software into a computer can be converted to a hardware implementation by well-known design rules.

FIG. 7 is a block diagram showing a technical architecture of the first user's mobile 1 and other users' mobile 2 to N.

The technical architecture includes a processor 322 (which may be referred to as a central processor unit or CPU) that is in communication with memory devices including secondary storage 324 (such as disk drives or memory cards), read only memory (ROM) 326, random access memory (RAM) 328. The processor 322 may be implemented as one or more CPU chips. The technical architecture further comprises input/output (I/O) devices 330, and network connectivity devices 332.

The I/O devices comprise a user interface (UI) 330a. A camera 330b and a geolocation module 330c may also be provided. The UI 330a may comprise a touch screen, keyboard, keypad or other known input device. The camera 330b allows a user to capture images and save the captured images in electronic form. The geolocation module 330c is operable to determine the geolocation of the communication device using signals from, for example global positioning system (GPS) satellites.

The secondary storage 324 is typically comprised of a memory card or other storage device and is used for non-volatile storage of data and as an over-flow data storage device if RAM 328 is not large enough to hold all working data. Secondary storage 324 may be used to store programs which are loaded into RAM 328 when such programs are selected for execution.

In this embodiment, the secondary storage 324 has a processing component 324a, comprising non-transitory instructions operative by the processor 322 to perform various operations of the method of the present disclosure. The ROM 326 is used to store instructions and perhaps data which are read during program execution. The secondary storage 324, the RAM 328, and/or the ROM 326 may be referred to in some contexts as computer readable storage media and/or non-transitory computer readable media.

The network connectivity devices 332 may take the form of modems, modem banks, Ethernet cards, universal serial bus (USB) interface cards, serial interfaces, token ring cards, fiber distributed data interface (FDDI) cards, wireless local area network (WLAN) cards, radio transceiver cards that promote radio communications using protocols such as code division multiple access (CDMA), global system for mobile communications (GSM), long-term evolution (LTE), worldwide interoperability for microwave access (WiMAX), near field communications (NFC), radio frequency identity (RFID), and/or other air interface protocol radio transceiver cards, and other well-known network devices. These network connectivity devices 332 may enable the processor 322 to communicate with the Internet or one or more intranets. With such a network connection, it is contemplated that the processor 322 might receive information from the network, or might output information to the network in the course of performing the above-described method operations. Such information, which is often represented as a sequence of instructions to be executed using processor 322, may be received from and outputted to the network, for example, in the form of a computer data signal embodied in a carrier wave.

The processor 322 executes instructions, codes, computer programs, scripts which it accesses from hard disk, floppy disk, optical disk (these various disk based systems may all be considered secondary storage 324), flash drive, ROM 326, RAM 328, or the network connectivity devices 332. While only one processor 322 is shown, multiple processors may be present. Thus, while instructions may be discussed as executed by a processor, the instructions may be executed simultaneously, serially, or otherwise executed by one or multiple processors.

Whilst the foregoing description has described exemplary embodiments, it will be understood by those skilled in the art that many variations of the embodiments can be made in accordance with the appended claims.

1. An electronic system for splitting a transaction cost between multiple parties comprising a processor configured to:
a) receive transaction data from a payment card server, the transaction data relating to transactions performed using a payment card associated with a first user;
b) on instruction by the first user, associate one or more other users with a group transaction identified from the transaction data along with an indication of a respective portion of the group transaction to be paid by each other user;
c) transmit a payment authorization request to each other user for payment of the other user's respective portion of the group transaction; and
d) upon authorization, receive confirmation of a transfer of funds equal to the other user's respective portion from a payment vehicle associated with the other user to a payment vehicle associated with the first user.

2. The system according to claim 1 wherein the processor is further configured to perform a registration process whereby the first user registers at least one payment card for subsequently receiving the transaction data from the payment card server, and wherein the receiving of the transaction data from the payment card server comprises the processor transmitting a request to the payment card server for access to the transaction data relating to transactions performed using the registered payment card, and wherein the payment card server transmits the transaction data to the processor via a personal electronic device of the first user.

3. The system according to claim 2 wherein the request to the payment card server comprises a password or PIN pre-registered with the payment card server and entered by the first user in an application (“App”) configured to run on the personal electronic device to authorize the transmittal of transaction data from the payment card server.

4. The system according to claim 2 wherein, whenever a subsequent transaction takes place using the payment card, the payment card server immediately transmits the transaction data associated with the subsequent transaction to the processor via the personal electronic device, as soon as the transaction is authorized.

5. The system according to claim 1 wherein the transaction data is stored in a memory of a personal electronic device of the first user and wherein transactions that occurred more than a predefined duration ago are deleted from the memory.

6. The system according to claim 1 wherein the transaction data comprises the date, time, location, merchant name, merchant ID and total cost of the transaction.

7. The system according to claim 1 wherein the processor is further configured to receive user input from the first user to associate the other users with the group transaction, the user input comprising selection of the other users from an address or phone book stored in a memory on a personal electronic device of the first user.

8. The system according to claim 1 wherein the payment authorization request is transmitted to each other user via at least one of a mobile internet connection or a Near Field Communication (NFC).

9. The system according to claim 1 wherein, if the other user already has an application configured to carry out the steps a) to d) on their personal electronic device, the request causes the application to open and prompt the other user to authorise a payment for a specified amount to the first user in relation to the group transaction; and if the other user does not already have the application on their personal electronic device, the request causes a personal electronic device of the first user to prompt the other user to download the application on their personal electronic device and register their details, the details comprising at least one payment vehicle associated with the other user for use in paying the first user for the group transaction.

10. The system according to claim 1 wherein the request comprises transaction data for the other user's information which comprises the respective portion of the group transaction owed by the other user, the total cost of the group transaction, the name of the merchant with whom the group transaction was made, the name of the first user initiating the split of the transaction and the names of the other users associated with the group transaction (if any).

11. The system according to claim 1 wherein each other user's payment to the first user is listed in their respective transaction data histories and comprises the amount they paid, the first user's name and merchant name associated with the group transaction, and wherein the first user's transaction data history comprises details of an original amount paid by the first user to the merchant plus the payments received from each other user associated with the group transaction with reference to the relevant group transaction and/or merchant.

12. A computerized method for splitting a transaction cost between multiple parties comprising:
a) receiving, at a processor, transaction data from a payment card server, the transaction data relating to transactions performed using a payment card associated with a first user;
b) on instruction by the first user, associating one or more other users with a group transaction identified from the transaction data along with an indication of a respective portion of the group transaction to be paid by each other user;
c) transmitting a payment authorization request to each other user for payment of the other user's respective portion of the group transaction; and
d) upon authorization, receive confirmation of a transfer of funds equal to the other user's respective portion from a payment vehicle associated with the other user to a payment account associated with the first user.

13. The method according to claim 12 implemented on a personal electronic device in the form of a mobile phone, personal computer, tablet, laptop, key-fob or personal digital assistant (PDA).

14. The method according to claim 12 further comprising a registration process whereby the first user registers at least one payment card for subsequently receiving the transaction data from the payment card server.

15. The method according to claim 12 further comprising an option to create a friend group comprising details of the other users that the first user frequently does group activities with or wishes to split transactions with, and an option to add or remove friends from the friend group for each group transaction.

16. The method according to claim 12 wherein step b) further comprises receiving from the first user, a selection of the other users for splitting of the transaction cost and the amount each other user is to pay or wherein step b) further comprises receiving from the first user, an instruction to divide the transaction cost equally amongst all users contributing and wherein a personal electronic device calculates a cost each individual user is to pay.

17. The method according to claim 16 wherein, where a straight split would result in a fraction being owed, the cost to each other user is rounded down to the nearest whole monetary denomination with a remaining balance to be paid by the first or a selected individual user.

18. The method according to claim 12 wherein the authorization in step d) further comprises a password or PIN entered into an application by the other user for verification purposes.

19. The method according to claim 12 further comprising receiving a message at the first user's personal electronic device to notify the first user of a rejection of the payment authorization request if the other user does not wish to pay the respective portion notified in the payment authorization request and he/she refuses to proceed with the payment request.

20. A non-transitory computer-readable medium having stored thereon program instructions for causing at least one processor to perform the method according to claim 12.
